(19) United States
(12) Patent Application Publication
(10) Pub. No.: US 2013/0302694 A1
(43) Pub. Date: Nov. 14, 2013

(54) POROUS PARTICLES COMPRISING AMINOPLASTIC

(71) Applicant: BASF SE, Ludwigshafen (DE)

(72) Inventors: Rebekka von Benten, Ludwigshafen (DE); Matthias Schade, Ludwigshafen (DE); Günter Scherr, Ludwigshafen (DE); Miran Yu, Ludwigshafen (DE)

(73) Assignee: BASF SE, Ludwigshafen (DE)

(21) Appl. No.: 13/856,537

(22) Filed: Apr. 4, 2013

Related U.S. Application Data
(60) Provisional application No. 61/620,481, filed on Apr. 5, 2012.

(51) Int. Cl. H01M 2/16

(52) U.S. Cl. CPC H01M 2/1653
USPC 429/249; 521/84.1

(57) ABSTRACT

The invention relates to particulate aminoplastic material composed of at least one aminoplastic, where the specific surface area of the particles is from 1 to 500 m²/g, and the average diameter of the particles is from 5 to 500 μm. The invention further relates to a process for producing said particulate aminoplastic material, to a molding which comprises particulate aminoplastic material, and also to a production process for the molding, and to the use of the particulate aminoplastic material and of the molding, for example as plastics membrane in batteries.

The invention relates to particulate aminoplastic material composed of at least one aminoplastic, where the specific surface area of the particles is from 1 to 500 m²/g, and the average diameter of the particles is from 5 to 500 μm. The invention further relates to a process for producing said particulate aminoplastic material, to a molding which comprises particulate aminoplastic material, and also to a production process for the molding, and to the use of the particulate aminoplastic material and of the molding, for example as plastics membrane in batteries.

A. Renner, Makromolekulare Chem. 120, 68-86 (1968), discloses the precipitation or gelling of melamine-formaldehyde condensates in the presence of protective colloids. Porous aminoplastic particles are described here with a specific surface area of <100 m²/g, for a particle size of from 1 to 5 μm and ≦500 Å. Above 100 m²/g, only particles in colloidal form are described. The chemical incorporation of the protective colloid into the polymer particles is also described. Methylcellulose, carboxymethylcellulose, and polyvinyl alcohol are listed as protective colloids. However, no particle structure is obtained in the presence of surfactants.

US-A-2010/0311852 describes the production of porous aminoplastic particles in a basic medium with addition of surfactants. Particle size is in the region of 5 μm, and a high specific surface area of up to 995 m²/g is achieved here after a carbonization process.

EP-A-0 415 273 describes a process for producing hard spherical mono- or oligodispersed particles of diameter of from 0.1 to 100 μm by condensing melamine-formaldehyde precondensates, where these are soluble in any ratio in water to give a clear solution, in an aqueous solution of a water-soluble polymer which bears strongly acidic groups and has a K value of from 100 to 160, at pH from 3 to 6 and at from 20 to 100° C. The resultant cloudy solution is condensed fully, until the precondensate has been consumed, thus producing a dispersion of the particles. The dispersion is neutralized. The particles can be used in the form of the aqueous dispersion or after isolation from the dispersion. The particles are hard, spherical, non-swellable particles which by way of example can be used as size for plastics, polishes, matting agents, or extruders, and/or as pigment.

U.S. Pat. No. 5,866,202 describes the production of fine pulverulent, polymeric materials with metal-coated surfaces which have a specific surface area of from 2 to 300 m²/g.

To this end, fine-particle aminoplastics made of aminoplastic precondensates are first produced in the form of microcapsules, microspheres, hollow spheres, or compact and/or porous powders by polycondensation and are then finally provided with a metallized surface.

DD277 911 A1 describes a process for producing fine-particle, spherical solid amino resins based on known amino resin precondensates by polycondensation in the following reaction system: water, organic solvent, and acid catalyst. The resultant products can in particular be used as corresponding sorbents, or support materials, or else in the form of fillers in polymers, and in comparison with known fine-particle solid amino resins they have an increased content of meso- and micropores, and also considerably increased sorbency for a very wide variety of hydrophobic liquids, or for hydrophobic substances dissolved in liquids.

DE-A-1495379 describes a process for producing fine, insoluble and infusible aminoplastic particles with an internal surface area >10 m²/g, by forming a solid phase from an aqueous solution of melamine and formaldehyde in a molar ratio of from 1.5 to 6 at temperatures of from 0° C. to 140° C. and at pH from 6 to 0, removing at least most of the inorganic particles therefrom, dewatering at temperatures of from 30 to 160° C., and comminuting to give an average particle size of less than 5 μm.

A disadvantage of the particulate aminoplastic materials of the prior art is that particle sizes achieved are mostly no more than 5 μm, a high specific surface area is obtained only after a carbonization process, high specific surface areas of >100 m^{b 2}/g are obtained only for colloidal particles, and particles with a maximum size of 5 μm are too small for many applications. A resultant disadvantage is that the shape and size of the particles make them unsuitable for many applications.

There is therefore a need for particles which by virtue of their size and shape, and attendant surface area, are suitable for many applications.

The object of the present invention is therefore to provide particulate aminoplastic materials which overcome the disadvantages of the prior art.

Accordingly, novel and improved porous particulate aminoplastic materials have been found which comprise at least 50% by weight of an aminoplastic, where the specific surface area of the particles is from 1 to 500 m²/g, preferably from 4 to 300 m²/g, particularly preferably from 10 to 250 m²/g, and the average diameter of the particles thereof is from 5 to 500 μm, preferably from 6 to 200 μm, and particularly preferably from 10 to 150 μm.

Particulate aminoplastic materials can by way of example be particulate solids obtainable by condensation of formaldehyde with compounds which comprise two or more amino groups, for example urea/thiourea, melamine, cyanamide, or diaminohexane.

Examples of aminoplastics suitable for the particles are urea-formaldehyde condensates, melamine-formaldehyde condensates, and mixtures of these, melamine-urea-formaldehyde condensates, melamine-urea-phenol-formaldehyde condensates, and mixtures of these. Said condensates can have been etherified partially or completely with alcohols, preferably C₁-C₄-alcohols, in particular methanol or butanol. Preference is given to etherified and/or non-etherified melamine-formaldehyde condensates, particularly non-etherified melamine-formaldehyde condensates. The aminoplastic can equally take the form of copolymer or of polymer blend. By way of example, an aminoplastic can be used with an acrylic resin.

For the purposes of another embodiment, the maximum D_{v0.9-D}_{v0.1}/D_{v0.5} distribution value of the particulate aminoplastic material is 2.5, preferably 1.5, in particular 0.7. The particulate aminoplastic material here can have two distributions (bimodal distribution), and the separation of the maximum values can be at least 40 μm, particularly preferably 20 μm. This can advantageously provide access to tailored applications, for example in size-exclusion applications. The definition of D_{v0.9},D_{v0.1}, and D_{v0.5} can be found in HORIBA Scientific, A Guidebook to Particle Size Analysis, on page 5.

For the purposes of another embodiment, the particulate aminoplastic material comprises from 70 to 100% by weight of aminoplastic and from 0 to 30% by weight of additional substances.

Examples of other additional substances that can be used are coupling agents which can bond, or couple, the particulate aminoplastic material into or onto a matrix. It is moreover possible to use fillers, for example silicon dioxide, precipitated silica, silica gel, or fumed silica, mica, montmorillonite, kaolinite, asbestos, talc, kieselguhr, vermiculite, natural and synthetic zeolites, cement, calcium silicate, aluminum silicate, sodium aluminum silicate, aluminum polysilicate, aluminum silica gels, gypsum and glass particles, or fine-particle fillers which are in essence insoluble in water, e.g. carbon black, wood charcoal, graphite, or titanium dioxide. The porous particulate aminoplastic materials of the invention preferably comprise from 85 to 100% by weight, particularly from 95 to 100% by weight, in particular 100% by weight, of aminoplastics, and from 0 to 15% by weight, particularly from 0 to 5% by weight, in particular from 0 to 3% by weight, of additional substances. In the event of concomitant use of the additional substances, the minimum amount thereof is preferably 0.01% by weight.

For the purposes of another embodiment of the particulate aminoplastic material of the invention, the particles comprise no polysaccharide. Polysaccharides (also termed glycans) are carbohydrate compounds formed from a large number (at least 10) of monosaccharides by way of glycosidic bonding. For the purposes of the present invention, a polysaccharide can be starch, modified starch, cellulose, microcrystalline cellulose, agar, carrageen, guar gum, gum arabic, pectin, xanthan gum, or a mixture thereof. There is advantageously no polysaccharide chemically bonded to the particulate aminoplastic material or mixed thereinto.

For the purposes of another embodiment, the aminoplastic particles have spherical geometry. This can advantageously improve flowability.

Another possibility, in another embodiment, is that the geometry of the aminoplastic particles is non-spherical.

For the purposes of another embodiment, the porosity of the aminoplastic particles is from 5 to 90%. The porosity is the ratio of unoccupied space within a structure to the aminoplastic material. It is preferable that the porosity of the porous particle is in the range from 5 to 85%, preferably in the range from 10 to 40%. By using various production parameters it is possible to produce various pore structures, examples being nano-, meso- or macropores. Pore size can be altered by way of example through further treatment steps, for example by using alkaline solutions or strong acids.

For the purposes of another embodiment, the aminoplastic particles are composed of a core and of a shell, where the shell at least partially surrounds the core. The core here can have spherical geometry, and it makes up from 1 to 50% by volume, in particular from 5 to 40% by volume, of the ideal volume of a sphere. It is preferable that the core has no porosity or has less porosity than the shell. By virtue of the structure based on a core and on a shell, the aminoplastic particles can advantageously have relatively low brittleness.

It is advantageous that the pore diameter is in the range from 1 nm to 20 μm, preferably in the range from 10 nm to 1 μm, particularly preferably in the range from 20 nm to 100 nm.

The invention further provides a process for producing particulate aminoplastic material, comprising the following steps:
a) providing an aminoplastic precondensate as component A,
b) adding at least one surfactant as component B and/or at least one polysaccharide as component C,
c) heating the mixture of components A, B, and C to at least 50° C. and then adding an acid as component D.

For the purposes of the present invention, an aminoplastic precondensate can be any of the following that are known to the person skilled in the art: urea-formaldehyde condensates, melamine-formaldehyde condensates, melamine-urea-formaldehyde condensates, or melamine-urea-phenol-formaldehyde condensates, where any of these have been precondensed to give oligomers and have been stabilized so that they can be stored. These are also known to the person skilled in the art as resins, for example aminoplastic resins or phenol-formaldehyde resins. To this end, by way of example, the aminoplastic precondensates can be precondensed under basic conditions and then rendered storage-stable in the neutral pH range. Said aminoplastic precondensates can by way of example have been partially etherified with C₁-C₄-alcohols. The aminoplastic precondensates are advantageously liquid at room temperature.

Aminoplastic resin here means polycondensates made of compounds having at least one carbamide group (where the carbamide group is also termed carboxamide group) optionally substituted to some extent with organic moieties, and of an aldehyde, preferably formaldehyde.

An aminoplastic resin which can be used and which is very suitable is any of the aminoplastic resins known to the person skilled in the art, preferably those known for the production of timber materials. Resins of this type, and also production thereof, are described by way of example in Ullmanns Enzyklopadie der technischen Chemie, 4., neubearbeitete und erweiterte Auflage [Ullmann's Encyclopedia of Industrial Chemistry, 4th, revised and extended edition], Verlag Chemie, 1973, pp. 403 to 424 “Aminoplaste” [Aminoplastics] and Ullmanns Encyclopedia of Industrial Chemistry, Vol. A2, VCH Verlagsgesellschaft, 1985, pp. 115 to 141 “Amino Resins”, and also in M. Dunky, P. Niemz, Holzwerkstoffe und Leime, Springer 2002, pp. 251 to 259 (UF resins) and pp. 303 to 313 (MUF and UF with small amount of melamine).

Preferred aminoplastic resins are polycondensates made of compounds having at least one carbamide group optionally substituted to some extent with organic moieties and of formaldehyde.

Particularly preferred aminoplastic resins are urea-formaldehyde resins (UF resins), melamine-formaldehyde resins (MF resins) and melamine-containing urea-formaldehyde resins (MUF resins).

Very great preference is further given to aminoplastic resins which are polycondensates made of compounds having at least one amino group optionally substituted to some extent with organic moieties and of aldehyde, where the molar ratio aldehyde:amino group optionally substituted to some extent with organic moieties is in the range from 0.3 to 1.0, preferably from 0.3 to 0.60, particularly preferably from 0.3 to 0.45, very particularly preferably from 0.30 to 0.40.

Very great preference is further given to aminoplastic resins which are polycondensates made of compounds having at least one amino group —NH2 and of formaldehyde, in which the molar ratio formaldehyde:—NH2 group is in the range from 0.3 to 1.0, preferably from 0.3 to 0.60, particularly preferably from 0.3 to 0.45, very particularly preferably from 0.30 to 0.40.

In another embodiment, particulate aminoplastic material is obtainable by the process of the invention, and the specific surface area of the aminoplastic particles here, which are composed of at least one aminoplastic, is preferably from 1 to 500 m²/g, with preference from 4 to 300 m²/g, with particular preference from 10 to 250 m²/g, and the average diameter of the particles thereof is from 5 to 500 μm, with preference from 6 to 200 μm, and with particular preference from 10 to 150 μm.

For the purposes of the present invention, the term “providing” in the form of step a) can mean that the aminoplastic precondensate has been dissolved in a solvent. The aminoplastic precondensate can be diluted with water to an extent of from 1 to 50% by weight, preferably to an extent of from 5 to 40% by weight, and particularly preferably to an extent of from 10 to 30% by weight. By way of example, an aminoplastic precondensate is used with a melamine/formaldehyde ratio in the range from 1:1 to 1:10 and preferably in the range from 1:2 to 1:6.

After step a), at least one surfactant is added. The surfactant here can be selected from the group comprising cationic surfactants, anionic surfactants, nonionic surfactants, amphoteric surfactants, and mixtures thereof.

Anionic surfactants that can be used are sulfates, sulfonates, carboxylates, phosphates, and mixtures thereof. Suitable cations here are alkali metals, such as sodium or potassium, or alkaline earth metals, such as calcium or magnesium, and also ammonium, substituted ammonium compounds, inclusive of mono-, di-, and triethanolammonium cations, and mixtures thereof.

Other anionic surfactants that can be used are salts of acylaminocarboxylic acids, the acylsarcosinates produced in an alkaline medium through reaction of fatty acid chlorides with sodium sarcosinate, alkyl and alkenyl glycerol sulfates, such as oleyl glycerol sulfates, alkyl phenol ether sulfates, alkyl phosphates, alkyl ether phosphates, isethionates, such as acyl isethionates, N-acyl taurides, alkyl succinates, sulfosuccinates, esters of sulfosuccinates, acyl sarcosinates, branched primary alkyl sulfates, salts of alkylsulfamidocarboxylic acids, and sulfates of alkyl polysaccharides, for example sulfates of alkyl polyglycosides.

Anionic sulfate surfactants are equally suitable. Anionic sulfate surfactants include the linear and branched, primary and secondary alkyl sulfates, aralkyl sulfates, alkyl ethoxy sulfates, fatty oleyl glycerol sulfates, alkyl phenol ethylene oxide ether sulfates, the C₉-C₁₇-acyl-N-(C₁-C₄-alkyl)- and -N-(C₁-C₂-hydroxyalkyl)glucamine sulfates, and sulfates of alkyl polysaccharides, for example the sulfates of alkyl polyglucoside.

Examples of anionic surfactants are fatty alcohol sulfates of fatty alcohols having from 8 to 22, preferably from 10 to 18, carbon atoms, for example C₉-C₁₁-alcohol sulfates, C₁₂-C₁₃-alkohol sulfates, cetyl sulfate, myristyl sulfate, palmityl sulfate, stearyl sulfate, and tallow fatty alcohol sulfate. Sodium dodecyl sulfate is particularly preferred.

Equally suitable anionic surfactants are sulfated ethoxylate C₈-C₂₂-alcohols (alkyl ether sulfates) and soluble salts of these. Compounds of this type are produced for example by first alkoxylating a C₈-C₂₂-, preferably C₁O-C₁₈, alcohol, for example a fatty alcohol, and then sulfating the alkoxylation product. The alkoxylation process preferably uses ethylene oxide, and the number of mols of ethylene oxide used per mole of fatty alcohol is from 2 to 50, preferably from 3 to 20. However, it is also possible to carry out the alkoxylation of the alcohols with propylene oxide alone, and optionally butylene oxide. Other suitable compounds are alkoxylated C₈-C₂₂-alcohols which comprise ethylene oxide and propylene oxide, or ethylene oxide and butylene oxide.

Anionic sulfonate surfactants are equally suitable. Anionic sulfonate surfactants suitable for use herein include the salts of linear C₅-C₂₀-alkylbenzenesulfonates, of aralkylbenzenesulfonates, of alkyl ester sulfonates, of primary or secondary C₆-C₂₂-alkanesulfonates, of C₆-C₂₄-olefinsulfonates, of sulfonated polycarboxylic acids, of alkyl glycerol sulfonates, of fatty acyl glycerol sulfonates, of fatty oleyl glycerol sulfonates, and include any mixture thereof. Sodium dodecylbenzenesulfonate is particularly preferred.

Nonionic surfactants can be condensates of ethylene oxide with a hydrophobic parent compound, formed by condensation of propylene oxide with propylene glycol.

Equally suitable nonionic surfactants can preferably be ethoxylates, propoxylates, and/or ethoxylates/propoxylates of fatty alcohols. Fatty alcohols are alkyl alcohols having from 6 to 22, in particular having from 8 to 18, carbon atoms in the alkyl moiety. The alkyl moieties are preferably linear, but can also be branched. They can be saturated or mono- or polyunsaturated. It is possible here to use fatty alcohol alkoxylates having only a single alkyl moiety or those having various alkyl moieties, for example those derived from the fatty acids in naturally occurring vegetable or animal fats and oils.

After step a) at least one polysaccharide is added as component C. For the purposes of the present invention, a polysaccharide can be starch, modified starch, cellulose, microcrystalline cellulose, agar, carrageen, guar gum, gum arabic, pectin, xanthan gum, or a mixture thereof. Particular preference is given to gum arabic.

After step b), components A, B, and C and optionally solvent are then heated to at least 40° C. to 120° C., preferably at least 50° C. to 115° C., in particular at least 60° C. to 150° C., and an acid is added as component D. It is possible to stir the resultant mixture for from 2 to 100 min., preferably for from 5 to 80 min., in particular from 8 to 30 min., prior to and/or after addition of the acid. For the purposes of the present invention, an acid can be, for example, an organic carboxylic acid, such as formic acid, acetic acid, or propionic acid, or an inorganic acid, for example a mineral acid, such as sulfuric acid and derivatives thereof, for example methanesulfonic acid or trifluoromethanesulfonic acid, hydrochloric acid, or phosphoric acid. The acid here can have been dissolved in a solvent, such as water, aqueous salt solutions, organic solvents, or a mixture thereof.

The acid can advantageously serve as hardener for reaction of the aminoplastic precondensate to give an aminoplastic.

In another embodiment of the invention, it is possible to execute at least two of the steps a), b), and c) simultaneously.

In a further subsequent step, a base can be used to terminate the reaction. Bases that can be used to terminate the reaction are organic and inorganic bases, for example triethylamine, diisopropylethylamine, or sodium hydroxide, potassium hydroxide, calcium hydroxide, sodium carbonate, potassium carbonate, calcium carbonate, sodium hydrogencarbonate, potassium hydrogencarbonate, or calcium hydrogencarbonate.

The process of the invention can moreover also comprise filtration, drying, and heat-conditioning of the particles. The specific surface area of the particles obtained after filtration, drying, and heat-conditioning is by way of example from 1 to 500 m²/g, where the average diameter of the particles is from 5 to 500 μm.

As a function of the production process, the aminoplastic condensate is produced in the form of suspension or block. From the suspension, filtration and washing gives the polymeric porous particles of the invention. Porous aminoplastic particles can moreover be produced from a block of the aminoplastic condensate after comminution.

For the purposes of one embodiment of the process of the invention, based on the entirety of components A to D and of a solvent, where these give 100% by weight, the amounts used are from 15 to 40% by weight of an aminoplastic precondensate as component A, from 1 to 15% by weight of a surfactant as component B, from 1 to 15% by weight of a polysaccharide as component C, from 0.01 to 5% by weight of an acid as component D, the remainder being solvent.

It is particularly preferable that, based on the entirety of components A to D and of a solvent, where these give 100% by weight, the amounts used are from 20 to 35% by weight of an aminoplastic precondensate as component A, from 1 to 10% by weight of a surfactant as component B, from 1 to 10% by weight of a polysaccharide as component C, from 0.01 to 4% by weight of an acid as component D, the remainder being solvent.

The invention further provides a process for producing the particulate aminoplastic material of the invention, comprising the following steps:
a) providing an aminoplastic precondensate as component A,
d) adding an acid as component D.

For the purposes of one embodiment of the process of the invention, based on the entirety of components A and D and of a solvent, where these give 100% by weight, the amounts used are from 15 to 60% by weight of an aminoplastic precondensate as component A and from 0.01 to 10% by weight of an acid as component D, the remainder being solvent.

The invention further provides a molding which comprises aminoplastic particles, where the specific surface area thereof is from 1 to 500 m²/g and the average diameter thereof is from 5 to 500 μm. The thickness of the molding is in the range from 0.01 μm to 1000 μm, preferably from 0.05 μm to 750 μm, and in particular from 0.1 μm to 500 μm. Materials that can be used for the molding are polymers selected from the group consisting of polyolefins, polycarbonates, polyacrylates, polyamides, polyurethanes, polyethers and/or polyesters.

Preference is given to polymers such as polyethylene, ultrahigh-molecular-weight polyethylene, polypropylene, ultrahigh-molecular-weight polypropylene, and to polybutene, polymethyl-pentene, polyisoprene, and copolymers thereof.

In another embodiment, it is possible to laminate a plurality of moldings, in particular in the form of plastics layers, on top of one another, where at least one plastics layer comprises particulate aminoplastic material, preferably aminoplastic particles, where the specific surface area thereof is from 1 to 500 m²/g and the average diameter thereof is from 5 to 500 μm, and particularly preferably aminoplastic particles produced by the process of the invention. In particular, the processing is achieved by means of extrusion.

The invention further provides a process for producing a molding of the invention, where the molding comprises aminoplastic particles, where the specific surface area thereof is from 1 to 500 m²/g, and the average diameter thereof is from 5 to 500 μm, by mixing a plastic with the aminoplastic particles and with at least one plasticizer, and processing to give a molding.

Plastic that can be used comprises polymers selected from the group comprising polyolefins, polycarbonates, polyacrylates, polyamides, polyurethanes, polyethers, and/or polyesters.

Preference is given to polymers such as polyethylene, ultrahigh-molecular-weight polyethylene, polypropylene, ultrahigh-molecular-weight polypropylene, and to polybutene, polymethyl-pentene, polyisoprene, and copolymers thereof.

The plasticizers known to the person skilled in the art can preferably be used here, in particular phthalate ester plasticizers, such as dibutyl phthalate, bis(2-ethylhexyl)phthalate, diisodecyl phthalate, dicyclohexyl phthalate, butylbenzyl phthalate, or ditridecyl phthalate.

The plasticizer here can be removed by means of organic solvents, typically 1,1,2-trichloro-ethylene, perchloroethylene, 1,2-dichloroethane, 1,1,1-trichloroethane, 1,1,2-trichloroethane, methylene chloride, chloroform, isopropanol, diethyl ether, or acetone, in order by way of example to obtain a microporous material which can be further processed, for example by calendering.

In another embodiment it is possible to produce a separator membrane by admixing the porous particle aminoplastic material described and one of the abovementioned processing plasticizers with thermoplastic polyolefin and, after mixing, producing a foil. The separator membrane is obtained after removal of the processing plasticizer with an abovementioned organic solvent, and subsequent calendering.

The invention further provides the use of aminoplastic particles, where the specific surface area thereof is from 1 to 500 m²/g, and the average particle diameter thereof is from 5 to 500 μm, as filler, as additive, as desiccant, as powder-flow aid, as thermal insulator, or as support material for further layers, or chemical substances.

Said particulate aminoplastic materials are moreover suitable as fillers in rubber applications, for example in tires for cars, for trucks, for motorcycles, for buses, for aircraft, or for specialized vehicles, or in technical rubber products, such as seals, hoses, NVH components, or wiper blades.

The particulate aminoplastic materials of the invention are moreover suitable as additive for thermoplastics parts and thermoplastics foils, e.g. as filler, release agent, structure-provider, or matting agent.

By virtue of large specific surface area, high porosity, and hydrophilic properties, the porous particulate aminoplastic materials of the invention are suitable as desiccants. The particulate aminoplastic materials of the invention are moreover suitable as support material for catalysts.

The particulate aminoplastic materials of the invention have low flammability and are suitable as powders and/or flow aids for fire extinguishers.

By virtue of high porosity, the particulate aminoplastic materials of the invention are suitable for thermal insulation applications in insulating sheets in the construction industry, in refrigeration equipment, in vehicles, or in industrial plants, in particular in what are known as vacuum insulating panels.

The particles of the invention are moreover suitable for use as support material for biologically active substances, e.g. plant-protection compositions, in particular pesticides, insecticides, herbicides, or fungicides, and also as powder-flow aid for biologically active substances and/or fertilizers.

The invention further relates to the use of the plastics layer as plastics film, plastics membrane, in particular in the form of separator membrane, or plastics foil. Said separator membrane is suitable by way of example for use in lead/sulfuric acid batteries or in lithium batteries.

By way of example, the particulate aminoplastic materials can be used as filler in separator membranes of primary and secondary cells.

The figures illustrate the present invention.

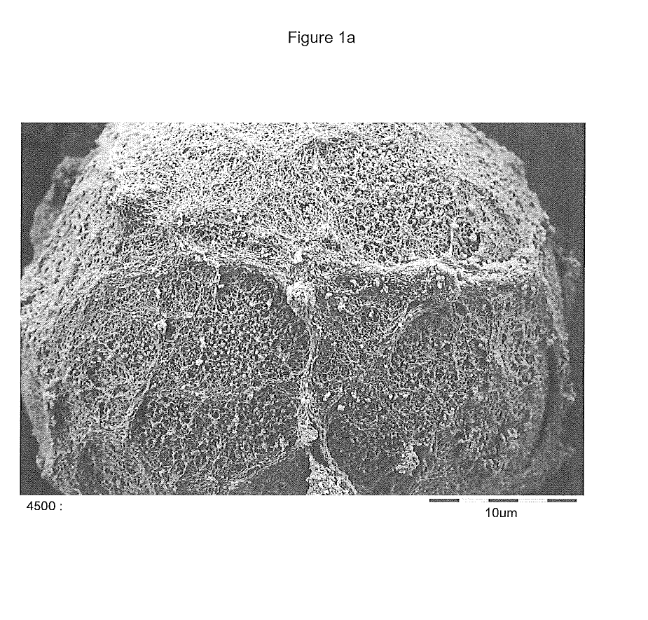

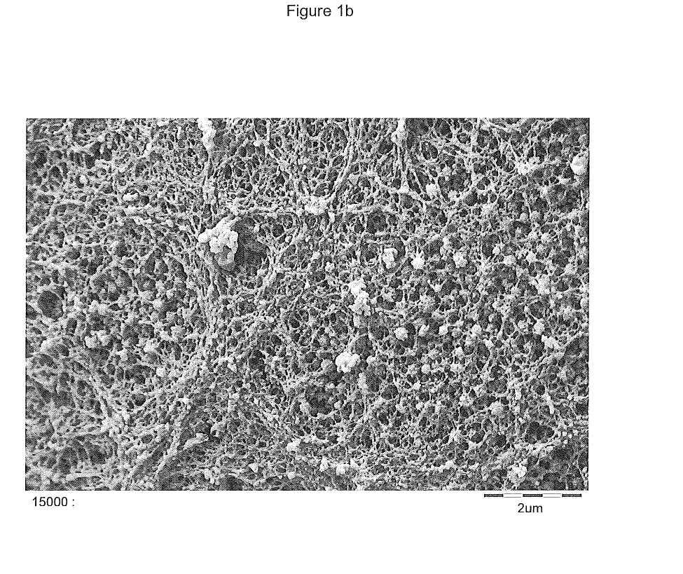

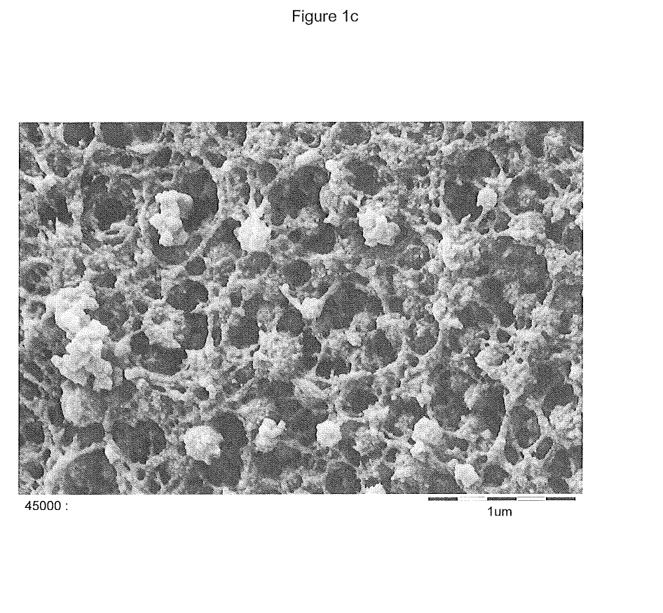

FIG. 1a shows a scanning electron micrograph of a spherical aminoplastic particle. The scale (bottom-right side) selected here is 10 μm, and the magnification here is 4500. The particle was produced by precipitation polymerization.

FIG. 1b shows a scanning electron micrograph of the aminoplastic particle shown in FIG. 1a, at a magnification of 15000. This clearly reveals the surface structure of the aminoplastic particle with its pores. The scale selected here was 2 μm.

FIG. 1c shows a scanning electron micrograph at magnification 45000. Here, the pores are clearly revealed. The scale selected is 1 μm.

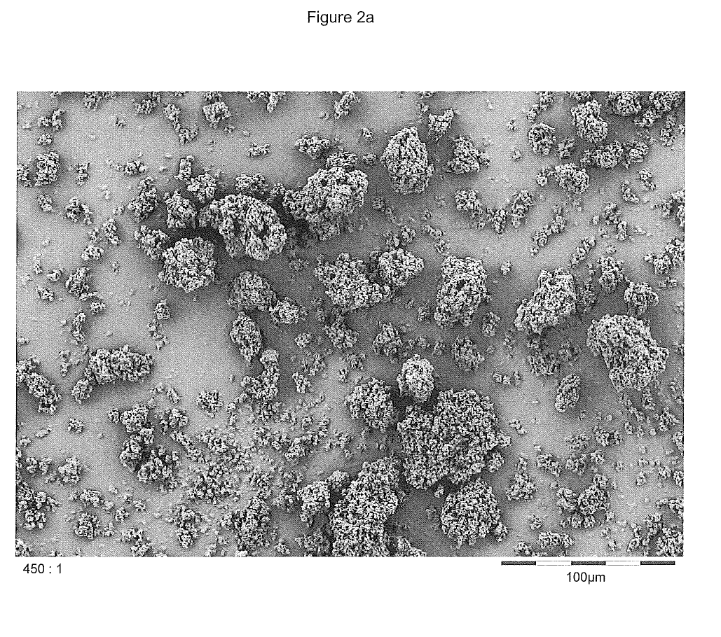

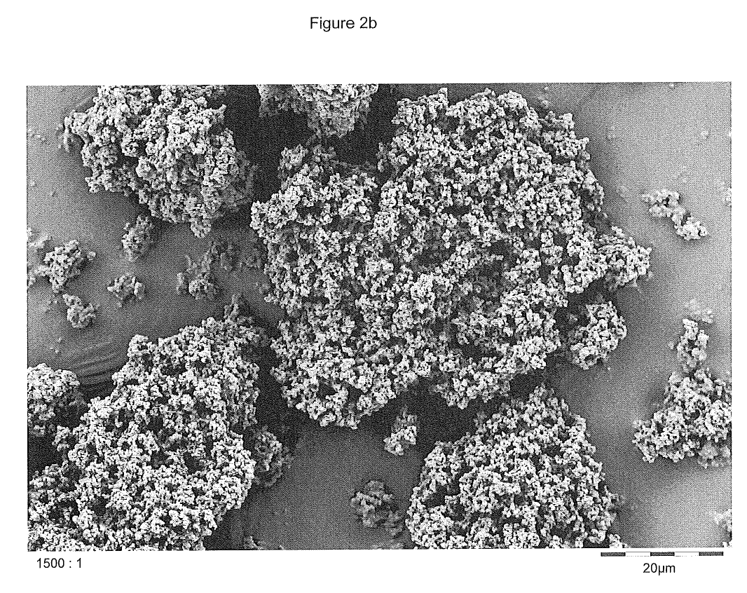

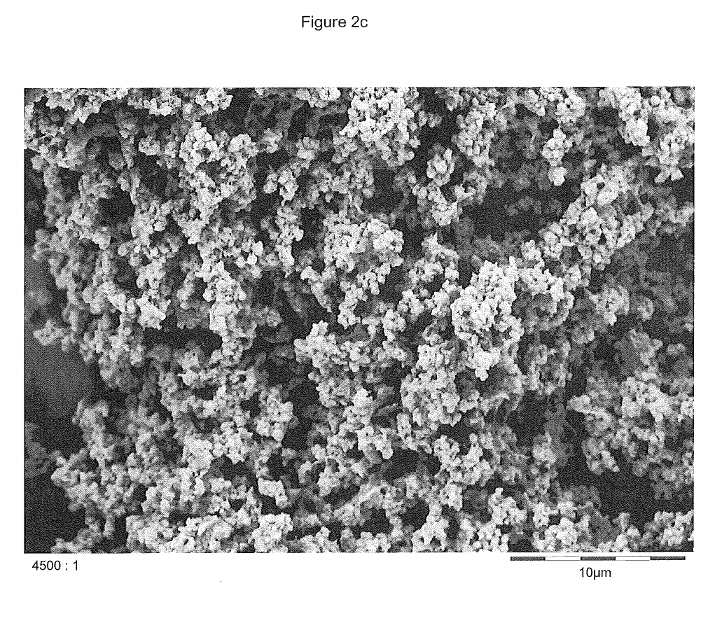

FIG. 2a shows aminoplastic particles which do not have a spherical structure and which have been produced by the block-casting process. These images were obtained by using a scanning electron microscope at magnification 450. The scale selected was 100 μm.

FIG. 2b shows the aminoplastic particles shown in FIG. 2a, with greater magnification of 1500, and the scale selected here was 20 μm.

FIG. 2c shows the image depicted in FIG. 2a, at a magnification of 4500. The scale selected here was 10 μm. A pore structure is clearly revealed.

### EXAMPLES

The examples below serve for further explanation of the invention.

### Example 1

### Production of Porous Aminoplastic Particles by Precipitation Polymerization

257.1 g (23% by weight) of a methanol-etherified, aqueous melamine-formaldehyde precondensate (70%, Luwipal 063, BASF SE) were dissolved in 342.9 g (31% by weight) of water, and then 37.5 g of sodium dodecyl sulfate (3% by weight) and 37.5 g (3% by weight) of gum arabic were admixed and the mixture was heated to 90° C., and 2.4 g of formic acid (0.2% by weight, 30% in water) were added. After stirring for 10 minutes at 90° C., 440 g (39% by weight) of water were added, and the mixture was further stirred for 20 minutes and, after cooling to 25° C., 2.8 g of sodium hydroxide (0.2% by weight; 25% in water) were added, and the supernatant liquor was removed by decanting after the resultant solid had sedimented. The sedimented solid is washed with acetone (3×1 L) and then removed by filtration. The product was then allowed to dry, with occasional stirring, first at room temperature and than at 150° C.

### Example 2

### Production of Porous Aminoplastic Particles by a Block-Casting Process

142.9 g of a methanol-etherified, aqueous melamine-formaldehyde precondensate (70%, Luwipal® 063, BASF SE) are dissolved in 190.4 g of water, and 41.7 g of formic acid (30% in water) are admixed. The reaction solution is poured into a suitable mold and hardened without stirring. In order to avoid surface filming, the mold is covered. After hardening, the resultant block is comminuted to the desired particle size and dried at room temperature and 150° C.

Particle size distribution is determined by way of laser scattering on the dried particles.

The average size of the particles produced in example 1 is 43 μm, and the specific surface area thereof is 10 m²/g.

The average particle size of the particles from example 2 is 66 μm, and the specific surface area thereof is 19.3 m²/g.

Specific surface area is determined by the method of Brunauer, Emmett, and Teller from the nitrogen-adsorption isotherm, or by means of mercury porosimetry.

Scanning electron microscopy (SEM) can be used to assess the particle geometry, and also to estimate size distribution and porosity.

Scanning electron micrographs of the powder produced in example 1 reveals spherical, highly porous particles. The particles from example 2 reveal highly porous, non-spherical geometry.

1-12. (canceled)

13. A particulate aminoplastic material comprising at least 50% by weight of an aminoplastic, wherein the specific surface area of the particles is from 1 to 500 m²/g and the average diameter of the particles is from 5 to 500 μm.

14. The particulate aminoplastic material according to claim 13, wherein the maximum Dv0.9-Dv0.1/Dv0.5 distribution value of the particulate aminoplastic material is <2.5.

15. The particulate aminoplastic material according to claim 13, wherein the aminoplastic particles are composed of a core and of a shell.

16. The particulate aminoplastic material according to claim 13, which comprises from 70 to 100% by weight of aminoplastic and from 0 to 30% by weight of additional substances.

17. The particulate aminoplastic material according to claim 13, which comprises no polysaccharide.

18. The particulate aminoplastic material according to claim 13, wherein the particles have spherical geometry.

19. The particulate aminoplastic material according to claim 13, wherein the porosity of the particles is from 5 to 90%.

20. A process for producing particulate aminoplastic material according to claim 13, comprising the following steps:
a) providing an aminoplastic precondensate as component A,
b) adding at least one surfactant as component B and/or at least one polysaccharide as component C,
c) heating the mixture of components A, B, and C to at least 50° C. and then adding an acid as component D.

21. The process according to claim 20, wherein, based on the entirety of components A to D and of a solvent, where these give 100% by weight, the amounts used are from 15 to 40% by weight of an aminoplastic precondensate as component A, from 1 to 15% by weight of a surfactant as component B, from 1 to 15% by weight of a polysaccharide as component C, from 0.01 to 5% by weight of an acid as component D, the remainder being solvent.

22. A process for producing particulate aminoplastic material according to claim 13, comprising the following steps:
a) providing an aminoplastic precondensate as component A,
d) adding an acid as component D.

23. A molding which comprises aminoplastic particles, where the specific surface area thereof is from 1 to 500 m2/g and the average diameter thereof is from 5 to 500 μm.

24. A process for producing a molding which comprises aminoplastic particles, where the specific surface area thereof is from 1 to 500 m2/g, and the average diameter thereof is from 5 to 500 μm, by mixing a plastic with the aminoplastic particles and with at least one plasticizer, and processing to give a molding.
